(19) United States
(12) Patent Application Publication
(10) Pub. No.: US 2023/0385072 A1
(43) Pub. Date: Nov. 30, 2023

(54) ELECTRONIC DEVICE AND METHOD OF OPERATING SAME

(71) Applicant: Sigmastar Technology Ltd., Xiamen (CN)

(72) Inventor: Wen-Shuai Xi, Xiamen (CN)

(21) Appl. No.: 18/121,333

(22) Filed: Mar. 14, 2023

(30) Foreign Application Priority Data
May 30, 2022 (CN) 202210605364.7

(51) Int. Cl. G06F 9/4401

(52) U.S. Cl. CPC G06F 9/4411

(57) ABSTRACT

An electronic device and a method of operating same are provided. The operation method of the electronic device includes the following steps: executing an operating system to generate an operation command; retrieving, from a lookup table according to the operation command, a driver command corresponding to the operation command; and executing the driver command.

This application claims the benefit of China application Serial No. CN202210605364.7, filed on May 30, 2022, the subject matter of which is incorporated herein by reference.

### BACKGROUND OF THE INVENTION

### 1. Field of the Invention

The present invention generally relates to electronic devices, and, more particularly, to device drivers of the electronic devices and operation methods of the electronic devices.

### 2. Description of Related Art

FIG. 1 shows a schematic diagram of an operating system architecture of a conventional embedded device. The operating system includes an application layer 110, a graphic user interface (GUI) library 120, a frame buffer framework 130, and a device driver layer 140. The frame buffer framework 130 is an interface that the Linux system provides for display devices. The frame buffer framework 130 abstracts the display buffer, hides the underlying differences of image hardware, and allows the application layer 110 to perform, in the graphics mode, read and write operations on the display buffer directly or indirectly (e.g., by calling a function of the GUI library 120). The device driver developed based on the frame buffer framework is referred to as a frame buffer device driver.

FIG. 2 shows a schematic diagram of another operating system architecture of a conventional embedded device. The operating system includes an application layer 210, a GUI library 220, and a device driver layer 230. The application layer 210 directly or indirectly (e.g., by calling a function of the GUI library 220) calls the device driver to control the hardware. The operating system architecture in FIG. 2 is suitable for the Real-time operating system (RTOS).

Although the frame buffer framework 130 of FIG. 1 can hide the underlying differences of image hardware, the frame buffer framework 130 is so highly coupled with the device driver layer 140 (i.e., the device driver layer 140 is extremely dependent on the data structure provided by the frame buffer framework 130 to communicate with upper layer(s) or the kernel) that porting the frame buffer device driver to a platform that does not include the frame buffer framework 130 (e.g., a platform employing the architecture of FIG. 2 as its operating system) takes lots of efforts. Similarly, due to the direct calling of the device driver layer 230 by the application layer 210 or the failure of the GUI library 220 to provide a common interface, the device driver layer 230 is highly coupled with the application layer 210 and/or the GUI library 220, making it very difficult for the device driver layer 230 to be ported to a platform with a frame buffer framework (e.g., a platform employing the architecture of FIG. 1 as an operating system).

The above problems are not only seen in frame buffer device drivers, but also in other types of device drivers.

### SUMMARY OF THE INVENTION

In view of the issues of the prior art, an object of the present invention is to provide electronic devices and methods of operating electronic devices, so as to make an improvement to the prior art.

According to one aspect of the present invention, an electronic device is provided. The electronic device includes a memory interface and a processor. The memory interface is configured to access a memory storing multiple program instructions or codes of an operating system. The processor is configured to execute the program instructions or codes to perform the following steps: executing the operating system to generate an operation command; retrieving, from a lookup table according to the operation command, a driver command corresponding to the operation command; and executing the driver command.

According to another aspect of the present invention, a method of operating an electronic device is provided. The method includes the following steps: executing an operating system to generate an operation command; retrieving, from a lookup table according to the operation command, a driver command corresponding to the operation command; and executing the driver command.

The technical means embodied in the embodiments of the present invention can solve at least one of the problems of the prior art. Therefore, in comparison with the prior art, it is easier to port device drivers from one platform to another by means of the present invention.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 shows a schematic diagram of an operating system architecture of a conventional embedded device.

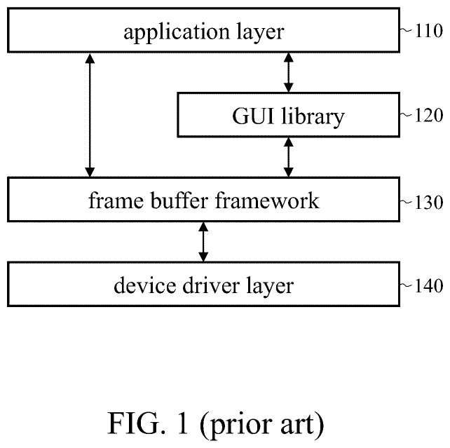

FIG. 2 shows a schematic diagram of another operating system architecture of a conventional embedded device.

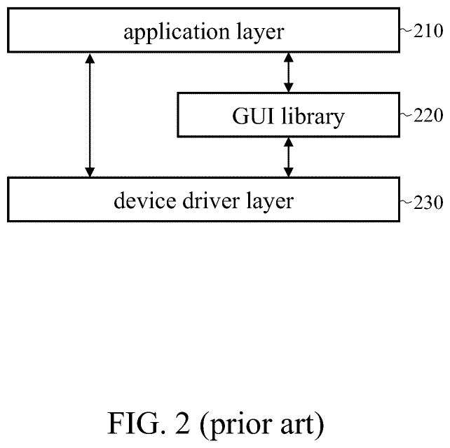

FIG. 3 shows a functional block diagram of an electronic device according to an embodiment of the present invention.

FIG. 4 shows a schematic diagram of an operating system architecture of the electronic device 300 of the present invention.

FIG. 5 shows a schematic diagram of another operating system architecture of the electronic device 300 of the present invention.

FIG. 6 shows a flowchart of an operation method of the electronic device according to an embodiment of the present invention.

FIG. 7 shows a lookup table according to an embodiment.

FIG. 8 shows the sub-steps of step S620 in FIG. 6.

FIG. 9 shows a flowchart of an operation method of the electronic device according to another embodiment of the present invention.

FIG. 10 shows an embodiment of the operation commands corresponding to the frame buffer framework.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes an electronic device and a method of operating the electronic device. On account of that some or all elements of the electronic device could be known, the detail of such elements is omitted provided that such detail has little to do with the features of this disclosure, and that this omission nowhere dissatisfies the specification and enablement requirements. Some or all of the processes of the method of operating the electronic device may be implemented by software and/or firmware and can be performed by the electronic device. A person having ordinary skill in the art can choose components or steps equivalent to those described in this specification to carry out the present invention, which means that the scope of this invention is not limited to the embodiments in the specification.

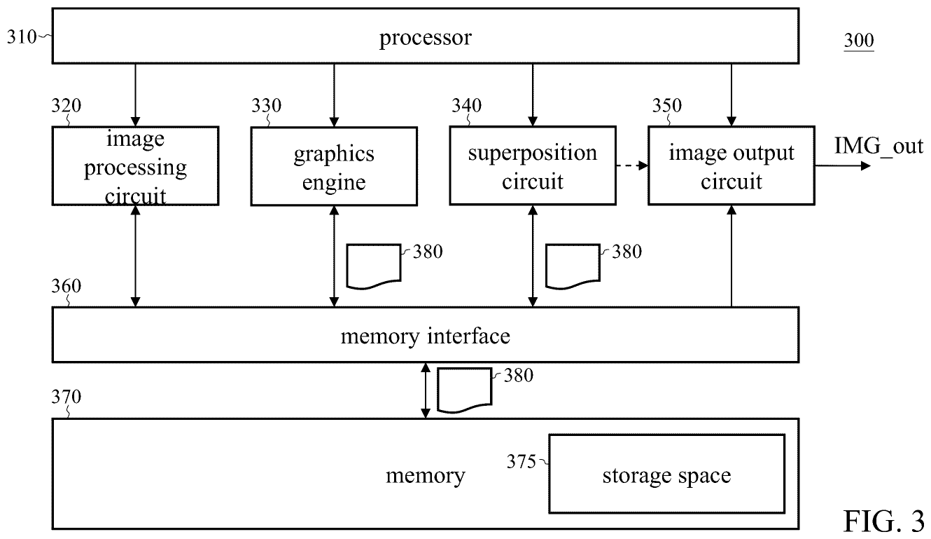

FIG. 3 shows a functional block diagram of an electronic device according to an embodiment of the present invention. The electronic device 300 includes a processor 310, an image processing circuit 320, a graphics engine 330, a superposition circuit 340, an image output circuit 350, a memory interface 360, and a memory 370. The processor 310, the image processing circuit 320, the graphics engine 330, the superposition circuit 340, and the image output circuit 350 access the memory 370 through the memory interface 360.

In one embodiment, the processor 310, the image processing circuit 320, the graphics engine 330, the superposition circuit 340, the image output circuit 350, and the memory interface 360 are integrated into a first chip, and the memory 370 is arranged on a second chip; for this case, the electronic device of the present invention refers to the first chip.

The processor 310 can be a circuit or electronic component with program execution capability, such as a central processing unit, microprocessor, micro-processing unit, digital signal processor (DSP), Application Specific Integrated Circuit (ASIC), or their equivalents. In some embodiments, the memory 370 stores program instructions or codes of the operating system of the electronic device 300, and the processor 310 runs the operating system (i.e., the processor 310 executes the program instructions or codes).

The image processing circuit 320 performs processing such as filtering, brightness adjustment, contrast adjustment, and color adjustment on image data. The graphics engine 330 can generate a preset image 380 (e.g., a menu). The superposition circuit 340 superposes the image processed by the image processing circuit 320 and the preset image 380 to generate a superposed image. The image processed by the image processing circuit 320 and the superposed image can be stored in a dedicated memory block of the memory 370. The image output circuit 350 can obtain the superposed image, which is the image to be displayed, from the superposition circuit 340 or the memory 370 and then packages or format-converts the superposed image to output the output image IMG_out.

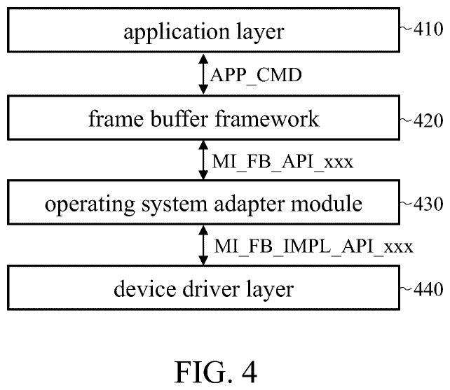

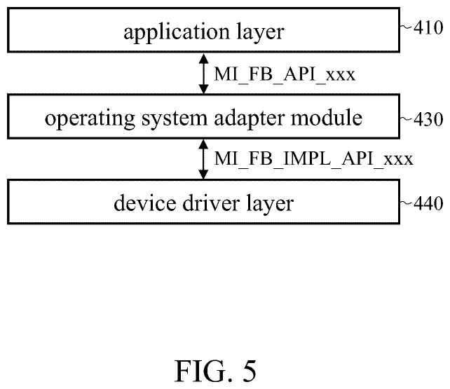

FIG. 4 shows a schematic diagram of an operating system architecture of the electronic device 300 of the present invention. The operating system includes an application layer 410, a frame buffer framework 420, an operating system adapter module 430, and a device driver layer 440. FIG. 5 shows a schematic diagram of another operating system architecture of the electronic device 300 of the present invention. FIG. is similar to FIG. 4, but the operating system in FIG. 5 does not include the frame buffer framework 420. As shown in FIG. 4 and FIG. 5, the electronic device 300 of the present invention utilizes the operating system adapter module 430 as an interface between the device driver layer 440 and the frame buffer framework 420 or the application layer 410. As a result, the frame buffer device driver of the device driver layer 440 can be executed on both operating systems without substantial modifications (or even any modification) thereto, meaning that porting of the frame buffer device driver is made easier.

As shown in FIG. 4 and FIG. 5, the operating system adapter module 430 converts the operation command MI_FB_API_xxx into the driver command MI_FB_IMPL_API_xxx (where “xxx” represents a variety of commands); that is, the operating system adapter module 430 generates the corresponding driver command MI_FB_IMPL_API_xxx according to the operation command MI_FB_API_xxx. In one embodiment, the operation command MI_FB_API_xxx is for creating a storage space 375 for display images in the memory 370, and the graphics engine 330 can accordingly draw the preset image 380 (e.g., a menu) and store the preset image 380 in the storage space 375. Then, the superposition circuit 340 can read the preset image 380 from the storage space 375 and superpose it with other image(s). In the embodiment of FIG. 4, the operation command MI_FB_API_xxx is generated by the frame buffer framework 420 in response to the application layer command APP_CMD. In the embodiment of FIG. 5, the operation command MI_FB_API_xxx is generated by the application layer 410. In other words, in the embodiment of FIG. 5, the operation command MI_FB_API_xxx can also be regarded as the application layer command APP_CMD. The application layer 410 includes applications and libraries (including but not limited to the GUI library), and the application layer command APP_CMD can be directly generated by the application (without calling the library), or indirectly generated by the application (with calling the library).

In the operating system architecture of FIG. 4, the operating system adapter module 430 registers the operation command MI_FB_API_xxx (i.e., registers application program interfaces (APIs)) to the frame buffer framework 420, so that the frame buffer framework 420 can call the corresponding API provided by the operating system adapter module 430 according to the command being executed or called. The registration process is the same as the device driver layer 140 registering commands to the frame buffer framework 130 in the conventional method.

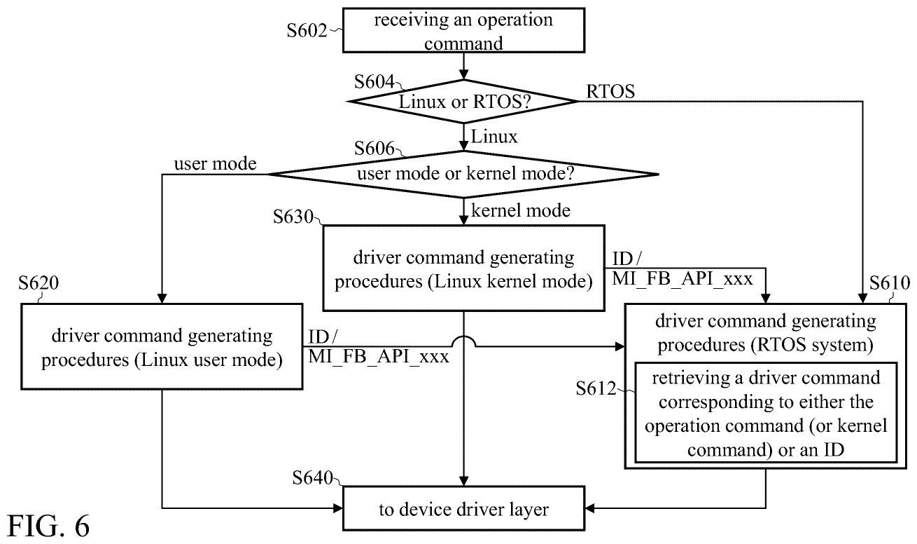

FIG. 6 shows a flowchart of the operation method of the electronic device according to an embodiment of the present invention. The flowchart shows the implementation details of the operating system adapter module 430. The process in FIG. 6 includes the following steps, which are executed by the processor 310.

Step S602: Receiving an operation command MI_FB_API_xxx. The operation command MI_FB_API_xxx can be generated by the frame buffer framework 420 (FIG. 4) or the application layer 410 (FIG. 5).

Step S604: Determining whether the electronic device 300 is currently running a Linux system or an RTOS system. The processor 310 may perform the determination in step S604 according to the system parameters; the details are well known to people having ordinary skill in the art and thus omitted for brevity. If the electronic device 300 is currently running an RTOS system (refer to the architecture of FIG. 5), the processor 310 performs step S610. If the electronic device 300 is currently running the Linux system, the processor 310 performs step S606.

Step S606: Determining whether the Linux system is currently operating in the user mode or kernel mode. If the Linux system is currently operating in the user mode, then the processor 310 performs step S620. If the Linux system is currently operating in the kernel mode, then the processor 310 performs step S630.

Step S610, step S620, and step S630 are respectively the driver command generating procedures for the RTOS system, Linux user mode, and Linux kernel mode and will be discussed in detail below. The processor 310 generates a driver command MI_FB_IMPL_API_xxx according to the operation command MI_FB_API_xxx in step S610, step S620, or step S630, and then in the device driver layer 440, the processor 310 executes the driver command MI_FB_IMPL_API_xxx or a corresponding command (step S640).

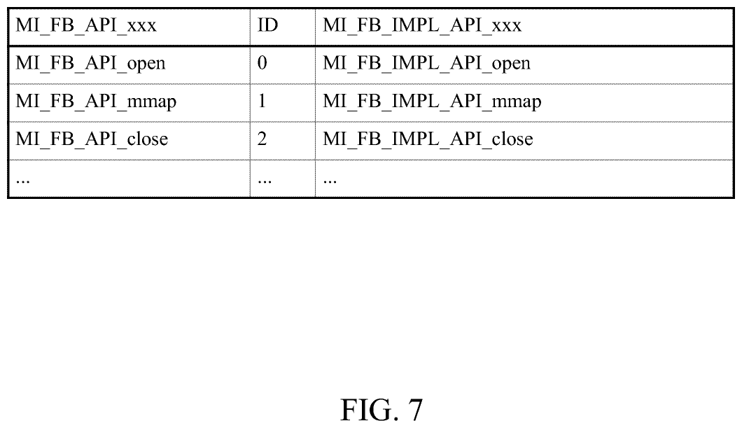

Step S610 in FIG. 6 includes sub-step S612. In sub-step S612, the processor 310 retrieves, by looking up in a lookup table, the driver command MI_FB_IMPL_API_xxx corresponding to either the operation command MI_FB_API_xxx (or kernel command) or an identification (ID). Reference is made to FIG. 7, which shows a lookup table according to an embodiment. In the lookup table, the first column is the operation command MI_FB_API_xxx, the second column is the ID corresponding to the operation command MI_FB_API_xxx (in some embodiments, an operation command MI_FB_API_xxx has a unique ID), and the third column is the driver command MI_FB_IMPL_API_xxx. For example, the processor 310 can retrieve, according to either the operation command MI_FB_API_open (MI_FB_API_mmap or MI_FB_API_close) or its corresponding ID 0 (1 or 2), the corresponding driver command MI_FB_IMPL_API_open (MI_FB_IMPL_API_mmap or MI_FB_IMPL_API_close). Note that the commands listed in the lookup table of FIG. 7 are intended to illustrate the invention by way of examples, rather than to limit the scope of the claimed invention. The actual lookup table may contain more commands. In some embodiments, the lookup table is stored in the memory 370.

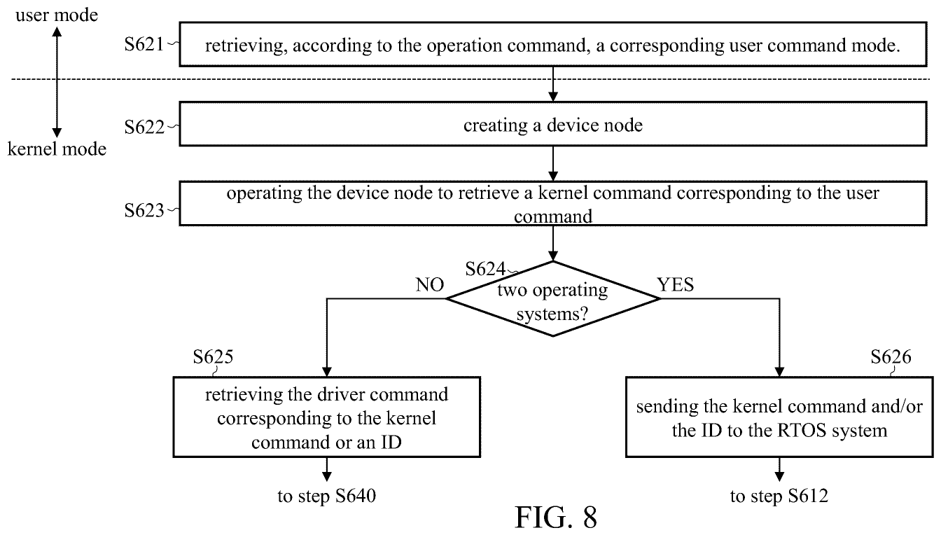

FIG. 8 shows the sub-steps of step S620 in FIG. 6, which are executed by the processor 310. The embodiment of FIG. 8 may correspond to the operating system architecture in FIG. 5. Step S621 is executed in the user mode of the Linux system, and steps S622-S626 are executed in the kernel mode of the Linux system.

Step S621: Retrieving, according to the operation command MI_FB_API_xxx, a corresponding user command in the Linux user mode. User commands are commands for operating hardware or devices in the Linux user mode, such as opening device files (open), input/output (I/O) control (ioctl), closing device files (close), etc. In some embodiments, the operation command MI_FB_API_xxx is the application layer command APP_CMD generated by the application layer 410 (reference can be made to the operating system architecture of FIG. 5).

Step S622: Creating a device node in the Linux kernel mode. Since this step is well known to people having ordinary skill in the art, the details are omitted for brevity.

Step S623: Operating the device node to retrieve a kernel command corresponding to the user command, for example, retrieving the I/O control (device_ioctl) of the kernel mode (i.e., the kernel command) corresponding to the I/O control (ioctl) of the user mode (i.e., the user command). Because for the device operation in the Linux system, the user commands and kernel commands are in one-to-one correspondence, the kernel commands and the operation commands MI_FB_API_xxx are also in one-to-one correspondence. In other words, the first column of the lookup table in FIG. 7 can be replaced with the kernel commands, or a new column of “kernel command” can be added in the lookup table. The kernel commands and the IDs are also in one-to-one correspondence.

Step S624: Determining whether the electronic device 300 includes two operating systems. In some embodiments, the electronic device 300 includes two operating systems (which may both be executed by one core of the processor 310 or respectively executed by two cores of the processor 310), such as a Linux system and an RTOS system. If the electronic device 300 includes two operating systems, the processor 310 performs step S626; otherwise, the processor 310 performs step S625.

Step S625: Retrieving the driver command MI_FB_IMPL_API_xxx corresponding to the kernel command or an ID, for example, by looking up in the lookup table of FIG. 7. As discussed above, since the kernel command is related to the operation command MI_FB_API_xxx, retrieving the driver command MI_FB_IMPL_API_xxx according to the kernel command is equivalent to retrieving the driver command MI_FB_IMPL_API_xxx according to the operation command MI_FB_API_xxx and/or its ID.

Step S626: Sending the kernel command and/or the ID to the RTOS system. As discussed above, since the kernel commands, the IDs, and the operation commands MI_FB_API_xxx may correspond to each other, sending the kernel command and/or the ID is equivalent to sending the corresponding operation command MI_FB_API_xxx. When the two operating systems are executed by the same core of the processor 310, step S626 can be executed by calling a function. In one embodiment where the two operating systems are respectively executed by two cores of the processor 310 or both executed by the same core of the processor 310, step S626 can be performed by sending the kernel command and/or the ID via Remote Processor Messaging (RPMsg). Since RPMsg is well known to people having ordinary skill in the art, the details are omitted for brevity. After the RTOS system receives the kernel command and/or the ID, the processor 310 performs step S612 to retrieve the driver command MI_FB_IMPL_API_xxx.

When the electronic device 300 includes two operating systems, the device driver is usually executed in the RTOS system due to the fast execution speed of the RTOS system. Therefore, in step S626 the kernel command and/or ID are/is sent to the RTOS system to retrieve the driver command MI_FB_IMPL_API_xxx in the RTOS system (i.e., step S612 in FIG. 6).

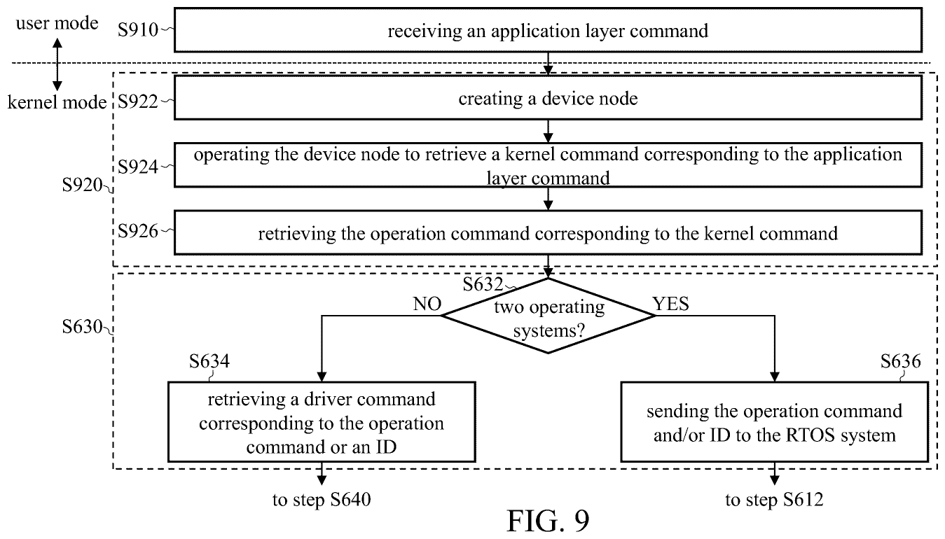

FIG. 9 shows a flowchart of the operation method of the electronic device according to another embodiment of the present invention; the operation method is executed by the processor 310. This embodiment may correspond to the operating system architecture in FIG. 4 and also include details of step S630 in FIG. 6 (i.e., steps S632, S634 and S636). The process of FIG. 9 includes the following steps, of which step S910 is executed in the user mode of the Linux system, and steps S920 and S630 are executed in the kernel mode of the Linux system.

Step S910: Receiving an application layer command APP_CMD. In some embodiments, the application layer command APP_CMD may be a user command in step S621. Please refer to the above discussion about step S621.

Step S920: The processor 310 executes kernel operations related to the frame buffer framework 420 and including steps S922-S926.

Step S922: Creating a device node. This step is an inherent operation of the frame buffer framework 420.

Step S924: Operating the device node to retrieve a kernel command corresponding to the application layer command. Step S924 is similar to step S623; please refer to the above discussion about step S623. When the application layer command APP_CMD is the user command, step S924 and step S623 are identical.

Step S926: Retrieving the operation command MI_FB_API_xxx corresponding to the kernel command. In reference to FIG. 4, because the operating system adapter module 430 has registered the APIs with the frame buffer framework 420 in advance (after registration, the operation commands MI_FB_API_xxx are in one-to-one correspondence with the kernel commands), the processor 310 can retrieve, according to the kernel command, the corresponding operation command MI_FB_API_xxx in the frame buffer framework 420.

Step S632: Determining whether the electronic device 300 includes two operating systems. This step is the same or similar to step S624. If the electronic device 300 includes two operating systems, the processor 310 performs step S636; otherwise, the processor 310 performs step S634.

Step S634: Retrieving a driver command corresponding to the operation command or an ID. This step is similar to step S612.

Step S636: Sending the operation command and/or ID to the RTOS system. This step is similar to step S626.

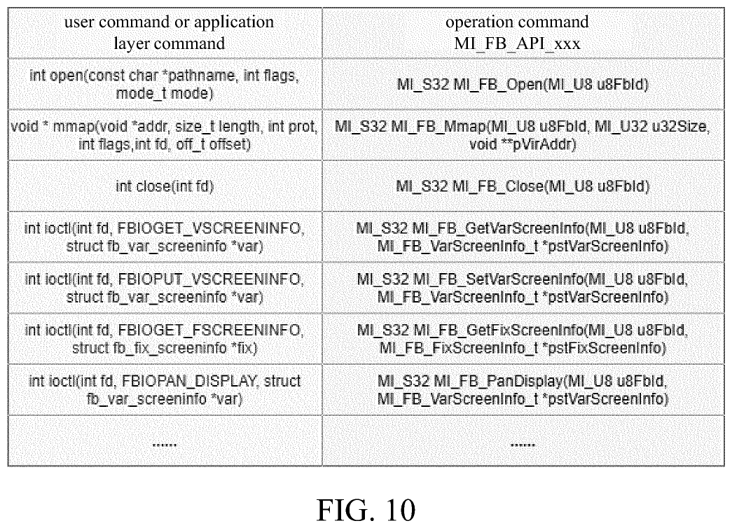

FIG. 10 shows an embodiment of the operation commands MI_FB_API_xxx corresponding to the frame buffer framework. As shown in FIG. 10, because the names of the operation commands MI_FB_API_xxx are similar to the names of the user interfaces (i.e., the user commands or application layer commands) of the frame buffer framework, the integration of the operating system adapter module 430 of the present invention into the original Linux system is made easier. For other types of device drivers, people having ordinary skill in the art can also name the operation commands MI_FB_API_xxx according to FIG. 10. Note that the naming method of FIG. 10 is given for illustrative purposes only, and the present invention is not limited thereto.

To sum up, since the operating system adapter module 430 of the present invention provides the adaption between the device driver layer 440 and the application layer 410 or frame buffer framework 420, it is easier for developers of electronic devices to port frame buffer device drivers to different platforms.

Although the above-discussed embodiments take frame buffer device drivers as an example, this is not a limitation to the present invention. People having ordinary skill in the art can apply the present invention to other types of device drivers according to the disclosure of the present invention.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An electronic device comprising:
a memory interface configured to access a memory storing a plurality of program instructions or codes of an operating system; and
a processor configured to execute the program instructions or codes to perform following steps:
(A) executing the operating system to generate an operation command;
(B) retrieving, from a lookup table according to the operation command, a driver command corresponding to the operation command; and
(C) executing the driver command.

2. The electronic device of claim 1, wherein the operation command is generated by an application layer of the operating system.

3. The electronic device of claim 2, wherein the operating system is a real-time operating system.

4. The electronic device of claim 1, wherein the operating system comprises a frame buffer framework and an application layer, and the frame buffer framework generates the operation command in response to an application layer command generated by the application layer.

5. The electronic device of claim 1, wherein when the operating system is a Linux system, the processor further performs following steps:
(D) receiving an application layer command;
(E) creating a device node;
(F) operating the device node to retrieve a kernel command corresponding to the application layer command; and
(G) retrieving the operation command corresponding to the kernel command.

6. The electronic device of claim 5, wherein the kernel command is a command of a frame buffer framework.

7. The electronic device of claim 1, wherein when the operating system is a Linux system and the processor further executes a real-time operating system, the processor further performing following steps:
sending the operation command or an identification corresponding to the operation command to the real-time operating system, wherein step (B) is executed in the real-time operating system.

8. The electronic device of claim 1, wherein when the operating system is a Linux system, step (B) comprises:
retrieving a user command corresponding to the operation command;
creating a device node;
operating the device node to retrieve a kernel command corresponding to the user command; and
retrieving the driver command according to the kernel command.

9. The electronic device of claim 1, wherein the operation command is related to creating a storage space in the memory, the electronic device further comprising:
a graphics engine configured to generate an image and store the image in the storage space corresponding to the operation command; and
a superposition circuit configured to read the image from the storage space and superpose the image with another image.

10. A method of operating an electronic device, the method comprising:
(A) executing an operating system to generate an operation command;
(B) retrieving, from a lookup table according to the operation command, a driver command corresponding to the operation command; and
(C) executing the driver command.

11. The method of claim 10, wherein the operation command is generated by an application layer of the operating system.

12. The method of claim 11, wherein the operating system is a real-time operating system.

13. The method of claim 10, wherein the operating system comprises a frame buffer framework and an application layer, and the frame buffer framework generates the operation command in response to an application layer command generated by the application layer.

14. The method of claim 10, wherein when the operating system is a Linux system, the method further comprises:
(D) receiving an application layer command;
(E) creating a device node;
(F) operating the device node to retrieve a kernel command corresponding to the application layer command; and
(G) retrieving the operation command corresponding to the kernel command.

15. The method of claim 14, wherein the kernel command is a command of a frame buffer framework.

16. The method of claim 10, wherein when the operating system is a Linux system and the electronic device further executes a real-time operating system, the method further comprising:
sending the operation command or an identification corresponding to the operation command to the real-time operating system, wherein step (B) is executed in the real-time operating system.

17. The method of claim 10, wherein when the operating system is a Linux system, step (B) comprises:
retrieving a user command corresponding to the operation command;
creating a device node;
operating the device node to retrieve a kernel command corresponding to the user command; and
retrieving the driver command according to the kernel command.

18. The method of claim 10, wherein the operation command is related to creating a storage space in a memory, the method further comprising:
using a graphics engine to generate an image and store the image in the storage space corresponding to the operation command; and
using a superposition circuit to read the image from the storage space and superpose the image with another image.
